(19) United States
(12) Patent Application Publication
(10) Pub. No.: US 2018/0053331 A1
(43) Pub. Date: Feb. 22, 2018

(54) DEVICE IDENTIFYING METHOD AND APPARATUS, AND STORAGE MEDIUM

(71) Applicant: Beijing Xiaomi Mobile Software Co., Ltd., Beijing (CN)

(72) Inventors: Weiguang JIA, Beijing (CN); Yongli SUN, Beijing (CN); Enxing HOU, Beijing (CN)

(73) Assignee: Beijing Xiaomi Mobile Software Co., Ltd., Beijing (CN)

(21) Appl. No.: 15/656,131

(22) Filed: Jul. 21, 2017

(30) Foreign Application Priority Data
Aug. 16, 2016 (CN) 201610678079.2

(51) Int. Cl. G06T 11/60; G09G 5/30; H04L 12/66; H04L 29/08

(52) U.S. Cl. CPC G06T 11/60; G09G 5/30; G06F 3/023; H04L 67/10; H04L 12/66

(57) ABSTRACT

The present disclosure relates to a device identifying method and apparatus, and a storage medium. The method may include: acquiring a device identification of a target smart device, when a preset physical button is triggered; and sending an identifying request carrying the device identification to a gateway device to which the target smart device connects, so that the gateway device forwards the identifying request to a terminal bound with the gateway device in advance. With this disclosure, when a plurality of smart devices are added to a gateway device during the same time period, a user can correlate a physical target smart device with its visual representation in a device list displayed by a terminal.

### CROSS-REFERENCE TO RELATED APPLICATION

This application is based on and claims priority of the Chinese Patent Application No. 201610678079.2, filed on Aug. 18, 2016, which is incorporated herein by reference in its entirety.

### TECHNICAL FIELD

The present disclosure is related to the technical field of communications, and more particularly to a device identifying method and apparatus, and a storage medium.

### BACKGROUND

In related art, a smart device can be added to its connected gateway device by utilizing a wireless communications technology. Further, a user can log into a corresponding device managing application (APP) by using a terminal bound with the gateway device in advance. Information on at least one smart device that has been added to a device list of the gateway device or the terminal is displayed by the device managing APP, and the user can remotely control all displayed smart devices by using the terminal.

However, when a plurality of smart devices are connected to the gateway device, the user may not be able to correlate the physical smart devices with their respective visual representations in the device list displayed on the terminal in one-to-one correspondence, which makes it inconvenient for the user to control the smart devices by using the terminal later.

### SUMMARY

In view of the foregoing, the present disclosure provides a device identifying method and apparatus, and a storage medium to remedy the deficiency in the related art.

According to a first aspect of the disclosure, there is provided a device identifying method for use in a terminal. The method may include: receiving an identifying request forwarded by a gateway device having the terminal bound therewith in advance; and identifying a target smart device in a device list currently displayed, according to the identifying request, wherein the identifying request requests the terminal to identify the target smart device in the device list and the identifying request carries a device identification of the target smart device, and the device list contains information on a plurality of smart devices controlled by the apparatus.

According to a second aspect of the disclosure, there is provided a device identifying apparatus for use in a terminal. The apparatus may include: a processor; and a memory storing instructions executable by the processor. The processor is configured to: receive an identifying request forwarded by a gateway device having the terminal bound therewith in advance; and identify a target smart device in a device list currently displayed, according to the identifying request, wherein the identifying request requests the terminal to identify the target smart device in the device list and the identifying request carries a device identification of the target smart device, and the device list contains information on a plurality of smart devices controlled by the apparatus.

According to a third aspect of the embodiments of the present disclosure, there is provided a non-transitory computer-readable storage medium having stored therein instructions that, when executed by a processor of a mobile terminal, cause the mobile terminal to perform acts including: receiving an identifying request forwarded by a gateway device having the terminal bound therewith in advance; and identifying a target smart device in a device list currently displayed, according to the identifying request, wherein the identifying request requests the terminal to identify the target smart device in the device list and the identifying request carries a device identification of the target smart device, and the device list contains information on a plurality of smart devices controlled by the mobile terminal.

It should be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1A is a schematic diagram illustrating a scenario for device identifying according to one or more exemplary embodiments of the present disclosure;

FIG. 1B illustrates an application user interface on an electronic device according to the scenario in FIG. 1A;

FIG. 1C illustrates a scenario including more connected devices according to one or more exemplary embodiments of the present disclosure;

FIG. 1D illustrates an application user interface on an electronic device according to the scenario in FIG. 1C;

FIG. 2 is a flowchart of a device identifying method according to an exemplary embodiment of the present disclosure;

FIG. 3A is a schematic diagram for illustrating physical buttons on a device according to an exemplary embodiment of the present disclosure;

FIG. 3B is a schematic diagram for illustrating physical buttons on a device according to an exemplary embodiment of the present disclosure;

FIG. 4 is a flowchart of another device identifying method according to an exemplary embodiment of the present disclosure;

FIG. 5 is a flowchart of yet another device identifying method according to an exemplary embodiment of the present disclosure;

FIG. 6 is a schematic diagram of a scenario for device identifying according to an exemplary embodiment of the present disclosure;

FIG. 7 is a flowchart of still another device identifying method according to an exemplary embodiment of the present disclosure;

FIG. 8 is a flowchart of a further device identifying method according to an exemplary embodiment of the present disclosure;

FIG. 9 is a schematic diagram of a scenario for device identifying according to an exemplary embodiment of the present disclosure;

FIG. 10A is a schematic diagram of scenario for device identifying according to an exemplary embodiment of the present disclosure;

FIG. 10B illustrates an application user interface on an electronic device according to the scenario in FIG. 10A;

FIG. 10C is a flowchart of yet a further device identifying method according to an exemplary embodiment of the present disclosure;

FIG. 10D is a schematic diagram illustrating a user interface on a device according to an exemplary embodiment of the present disclosure;

FIG. 10E is a schematic diagram illustrating a user interface on a device according to an exemplary embodiment of the present disclosure;

FIG. 11 is a block diagram of a device identifying apparatus according to an exemplary embodiment of the present disclosure;

FIG. 12 is a block diagram of another device identifying apparatus according to an exemplary embodiment of the present disclosure;

FIG. 13 is a block diagram of yet another device identifying apparatus according to an exemplary embodiment of the present disclosure;

FIG. 14 is a block diagram of still another device identifying apparatus according to an exemplary embodiment of the present disclosure;

FIG. 15 is a block diagram of a further device identifying apparatus according to an exemplary embodiment of the present disclosure;

FIG. 16 is a block diagram of yet a further device identifying apparatus according to an exemplary embodiment of the present disclosure;

FIG. 17 is a schematic structural diagram of a device identifying apparatus according to an exemplary embodiment of the present disclosure;

FIG. 18 is a schematic structural diagram of another device identifying apparatus according to an exemplary embodiment of the present disclosure;

FIG. 19 is a schematic structural diagram of a device identifying system according to an exemplary embodiment of the present disclosure;

FIG. 20 is a schematic structural diagram of another device identifying system according to an exemplary embodiment of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise indicated. The implementations set forth in the following description of embodiments do not represent all implementations consistent with the disclosure. Instead, they are merely examples of apparatuses and methods consistent with aspects related to the disclosure as recited in the appended claims.

The terms used herein are for the purpose of illustrating the embodiments only, rather than limiting the present disclosure. The terms “a”, “said” and “the” of singular forms used in the present description and the attached claims are also intended to include their plural forms, unless otherwise clearly specified in the context. It can also be appreciated that the term “and/or” as used herein refers to any or all possible combinations of one or more associated items as listed.

It can be appreciated that, while the terms “first”, “second”, “third” and so on may be used herein to describe various information, such information is not limited to these terms, which are only used to distinguish between different information of the same category. For example, the first information can also be referred to as the second information, and similarly the second information can also be referred to as the first information, without departing from the scope of the present disclosure. Depending on the context, the term “if” as used herein may be interpreted as “when”, “while”, or “in response to determining”.

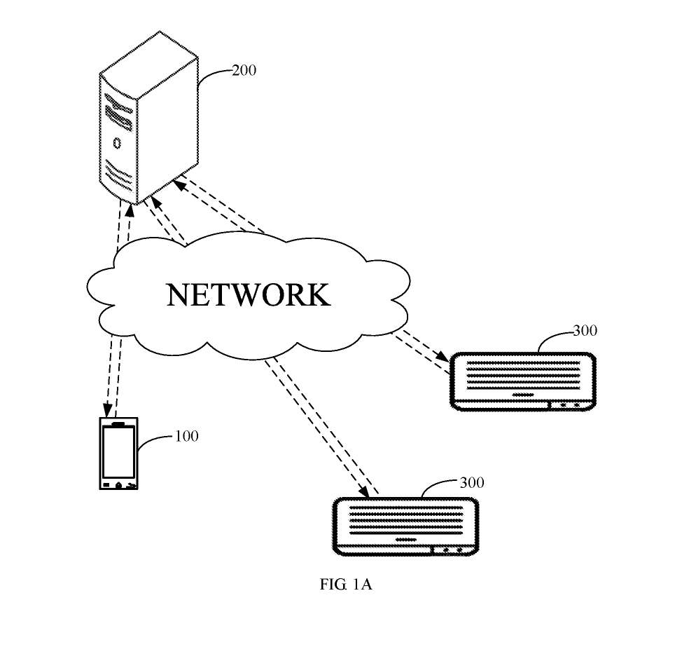

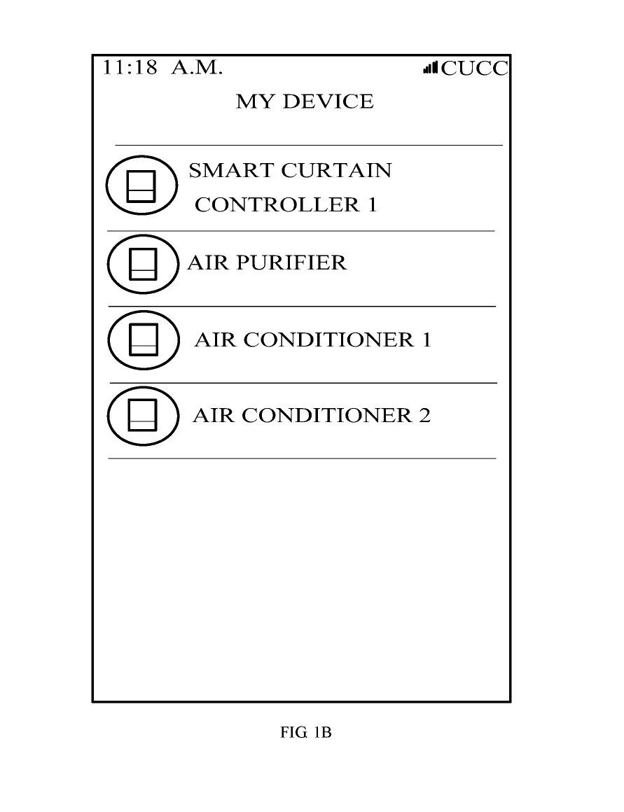

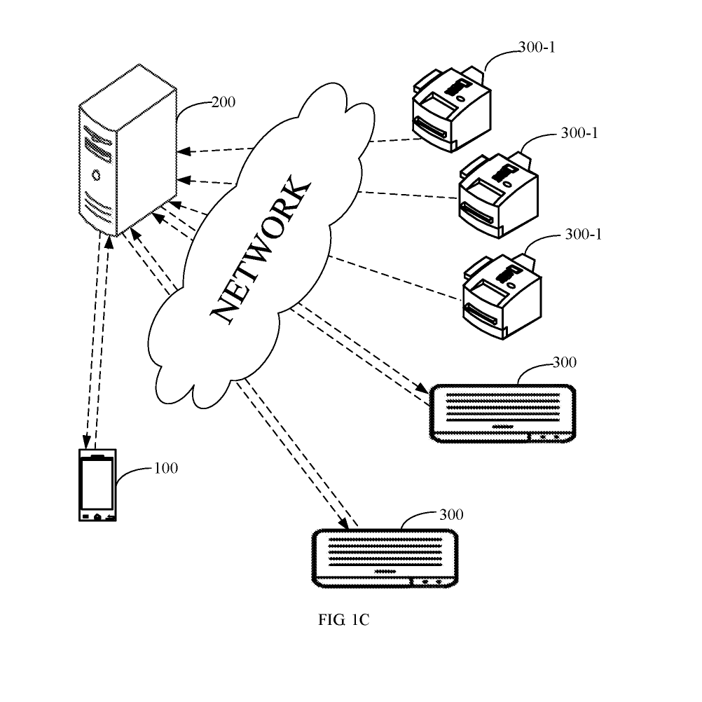

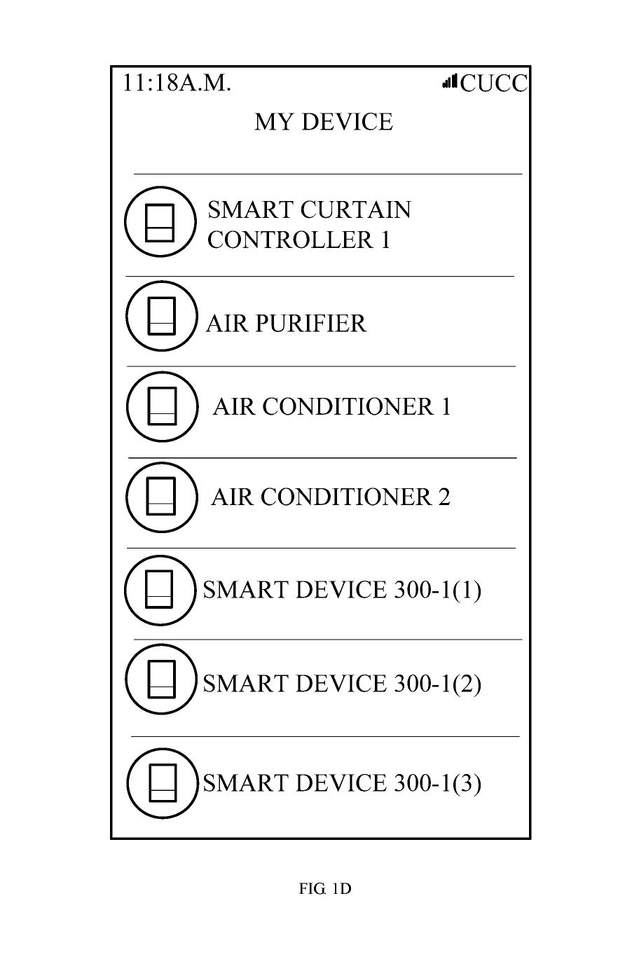

Before describing device identifying methods provided by embodiments of the disclosure, scenarios for applying the embodiments of the disclosure will be described. As shown in FIG. 1A, a gateway device 200 has a terminal 100 bound therewith in advance. The gateway device 200 enables the function of allowing a smart device 300 to automatically access. The smart device 300 may regularly scan for a gateway device. When the gateway device 200 is found, the smart device 300 may access the gateway device 200 in a wireless connection manner, such as Wireless Fidelity (WIFI), Bluetooth or Zigbee. Alternatively or additionally, the smart device is provided with an indicating function, and is a smart temperature/humidity sensor, a smart air conditioner, a smart water heater or the like.

A user may log into a pre-installed device managing APP to check and control all smart devices 300 added to a target device, which is the terminal 100 or the gateway device 200. The device managing APP may display a device list on the terminal 100. The device list includes information on at least one smart device added into a device list of the target device, as shown in FIG. 1B.

When a smart device 300-1 is newly added to the gateway device 200, the user may determine the newly added smart device 300-1 by refreshing the device list. When a plurality of smart devices 300-1 are newly added during the same time period as shown in FIG. 1C, the plurality of smart devices 300-1 will appear in the refreshed device list as shown in FIG. 1D.

In this case, the user perhaps cannot correlate the physical smart device 300-1 with its visual representation in the device list displayed on the terminal 100. To address this problem, device identifying methods according to embodiments of the disclosure are provided, which make it easier for the user to correlate the physical smart device 300-1 with its visual representation in the device list displayed on the terminal.

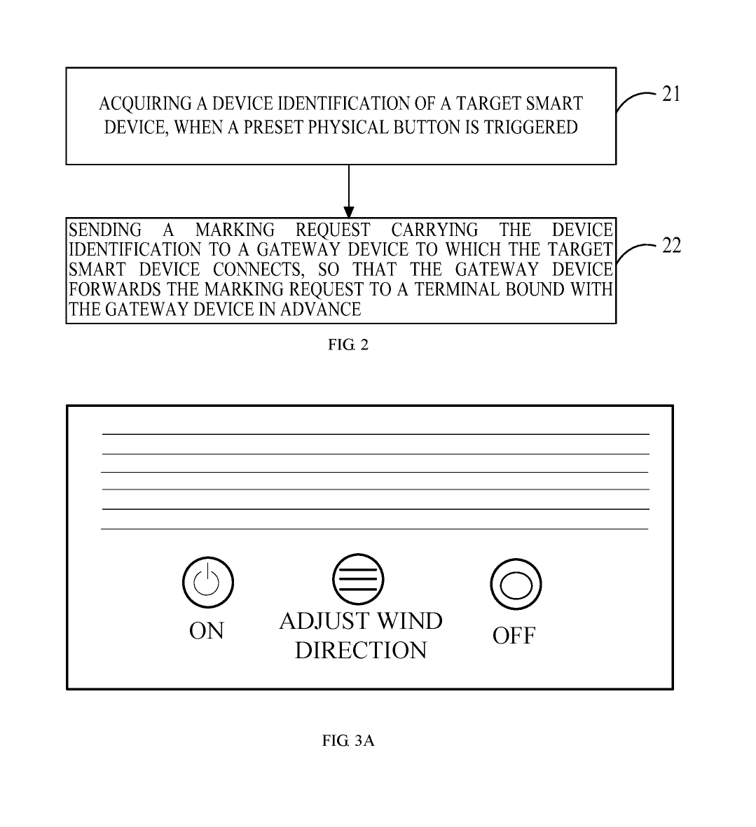

A device identifying method provided by the disclosure may be used in a target smart device. Optionally, the target smart device is provided with an indicating function, and is a smart temperature/humidity sensor, a smart air conditioner, a smart water heater or the like. FIG. 2 illustrates the device identifying method according to the exemplary embodiment. As shown, the method comprises the following steps:

In step 21, a device identification of the target smart device is acquired, when a preset physical button is triggered.

In the embodiment of the disclosure, the preset physical button may be provided on the target smart device for identifying the target smart device. Optionally, the preset physical button may be a newly added physical button dedicated for identifying the target smart device itself or may be an existing button on the target smart device which is reused as the preset physical button.

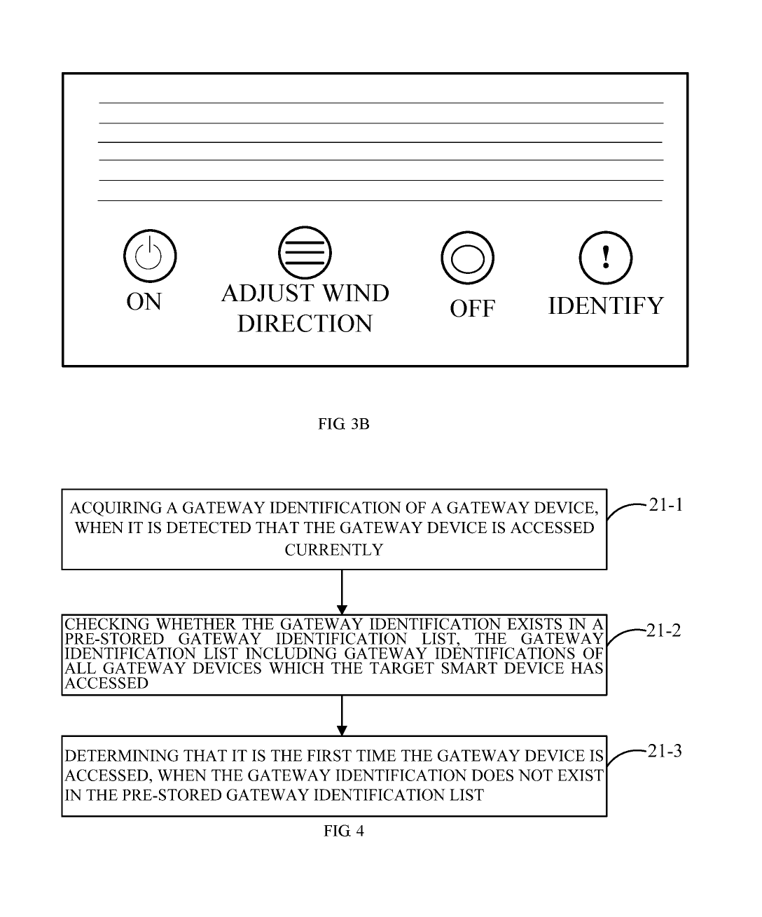

For example, FIG. 3A shows a smart air conditioner including three physical buttons. A newly added preset physical button may be provided, as shown in FIG. 3B.

Alternatively, an existing button such as a power-on button may be reused to trigger the identifying process. When the user presses the power-on button for a time length longer than a preset time length, the smart air conditioner determines that the user triggers the preset physical button for identifying the smart air conditioner itself

In this step, considering that a user's help is required when the target smart device accesses a gateway device for the first time, the user typically needs to correlate the target smart device with its representation displayed in the device list, when the target smart device is found in the device list for the first time. Therefore, it is practical to detect whether the preset physical button for identifying the target smart device is triggered according to the disclosed method, only when the target smart device accesses the gateway device for the first time. Alternatively or additionally, the disclosed method may only be triggered when there are two smart devices of the same type in the device list.

Here, for detecting whether it is the first time the gateway device is accessed, another device identifying method is provided as shown in FIG. 4. The method shown in FIG. 4 is based on the embodiment shown in FIG. 2 and comprises the following steps.

In step 21-1, when it is detected that the gateway device is accessed currently, a gateway identification of the gateway device is acquired.

In this step, the gateway device has enabled the function of allowing automatic accessing, and the target smart device may scan for a gateway device. When the gateway device is found, the gateway device is automatically accessed in a wireless connection manner, such as WIFI, Bluetooth or Zigbee.

Further, the target smart device may acquire the gateway identification of the gateway device through the wireless connection with the gateway device. Optionally, the gateway identification may be information which can identify the gateway device, such as a Medium Access Control (MAC) address of the gateway device.

In step 21-2, it is checked whether the gateway identification exists in a pre-stored gateway identification list. The gateway identification list includes gateway identifications of all gateway devices which the target smart device has accessed.

In one or more embodiments of the disclosure, the target smart device may record, in the gateway identification list, gateway identifications of all gateway devices that have been accessed. In this step, after the terminal accesses the gateway device and acquires the gateway identification of the gateway device, it may check whether the gateway identification exists in the pre-stored gateway identification list.

In step 21-3, when the gateway identification does not exist in the pre-stored gateway identification list, it is determined that it is the first time the gateway device is accessed.

In this step, if the gateway identification does not exist in the gateway identification list, it is determined that it is the first time the gateway device is accessed. Otherwise, it is determined that it is not the first time the gateway device is accessed.

In the embodiment of the disclosure, when determining that it is the first time the gateway device is accessed, the target smart device automatically detects whether the preset physical button is triggered.

When determining that the preset physical button is triggered, the target smart device may acquire its own device identification. Optionally, the device identification may be information which can identify the target smart device, such as a factory serial number of the target smart device.

In step 22, an identifying request carrying the device identification is sent to a gateway device to which the target smart device connects, so that the gateway device forwards the identifying request to a terminal bound with the gateway device in advance.

The identifying request requests the terminal to mark or identify the target smart device in a device list currently displayed, and the device list contains information on at least one smart device added into a device list of a target device. The identifying request may also be referred as a marking request. The target device is the terminal or the gateway device. As long as it has been added to the target device, the smart device added to the target device may be online or powered on or may be offline or not powered on. The device list may be stored on either the terminal or the gateway device, or on both the terminal and the gateway device.

When the target device is the terminal, the device list includes smart devices added to the terminal in a wired or wireless connection manner. Optionally, the wired connection manner may be via a data line or the like, and the wireless connection manner may include WIFI, Bluetooth, Zigbee or the like.

For example, when the target device is the terminal and there are a plurality of Bluetooth earphones added to the terminal via Bluetooth connections, then the device list includes the plurality of Bluetooth earphones.

When the target device is the gateway device, the device list may include a plurality of smart devices added to the gateway device. Optionally, the smart devices may be those added to the gateway device in a smart home. For example, when there are a plurality of smart air conditioners in the smart home and the smart air conditioners have been added to the gateway device, then the device list may include the smart air conditioners.

In this step, the terminal smart device automatically generates the identifying request, and sends the identifying request carrying the device identification to the gateway device through the wireless connection previously established with the gateway device.

In the embodiment of the disclosure, after the gateway device receives the identifying request through the wireless connection established with the target smart device, it directly forwards the identifying request to the terminal bound with the gateway device in advance. Then, the terminal marks or identifies the target smart device in the device list according to the identifying request in the manner described hereinafter.

In one or more embodiments of the disclosure, when needing to correlate the physical target smart device with its visual representation in the device list currently displayed by the terminal, the user may trigger the preset physical button on the target smart device. The target smart device automatically sends the identifying request to the gateway device and the gateway device forwards the identifying request to the terminal, so that the target smart device is identified in the device list on the terminal, thereby improving intelligence of the terminal and bringing convenience to the user.

Another device identifying method provided by an embodiment of the disclosure may be used in a terminal, such as a smart phone, a tablet, a personal digital assistant (PDA). FIG. 5 illustrates the device identifying method according to the exemplary embodiment of the disclosure. As shown, the method comprises the following steps.

In step 31, an identifying request forwarded by a gateway device having the terminal bound therewith in advance is received.

The identifying request requests the terminal to identify the target smart device in a device list currently displayed, and the device list contains information on at least one smart device added into a device list of a target device. The target device may be the terminal or the gateway device. As long as it has been added to the target device, the smart device added to the target device may be online or powered on or may be offline or not powered on.

In this step, the terminal may receive the identifying request forwarded by the gateway device having the terminal bound therewith in advance.

In step 32, the target smart device is identified in a device list currently displayed, according to the identifying request.

In this step, the terminal may find the target smart device in the device list according to the device identification carried by the identifying request, and further identify the target smart device in the device list according to any of the following manners.

In a first manner, the target smart device is identified in a different display manner.

Alternatively or additionally, the terminal may display, in the device list, the target smart device in a first display manner and another smart device added to the target device other than the target smart device in a second display manner. The first display manner is different from the second display manner.

The first display manner may differ from the second display manner in terms of any of color, font, background color, text size and stroke thickness. The user may set the first display manner and the second display manner respectively. Here, the terminal may randomly determine two different display manners, which correspond to the first display manner and the second display manner respectively. For example, the target smart device may be marked with a first color and the other smart devices are marked with a different color.

For example, the first display manner may be set as a bold, red and “Song” font, and the second display manner may be set as a black and “regular script” font. Accordingly, when the target smart device is identified in the device list, it may be displayed in “Song” font, red and bold, and all other smart devices in the device list than the target smart devices may be displayed in “regular script” font and black.

In a second manner, the target smart device is identified by adding a preset label.

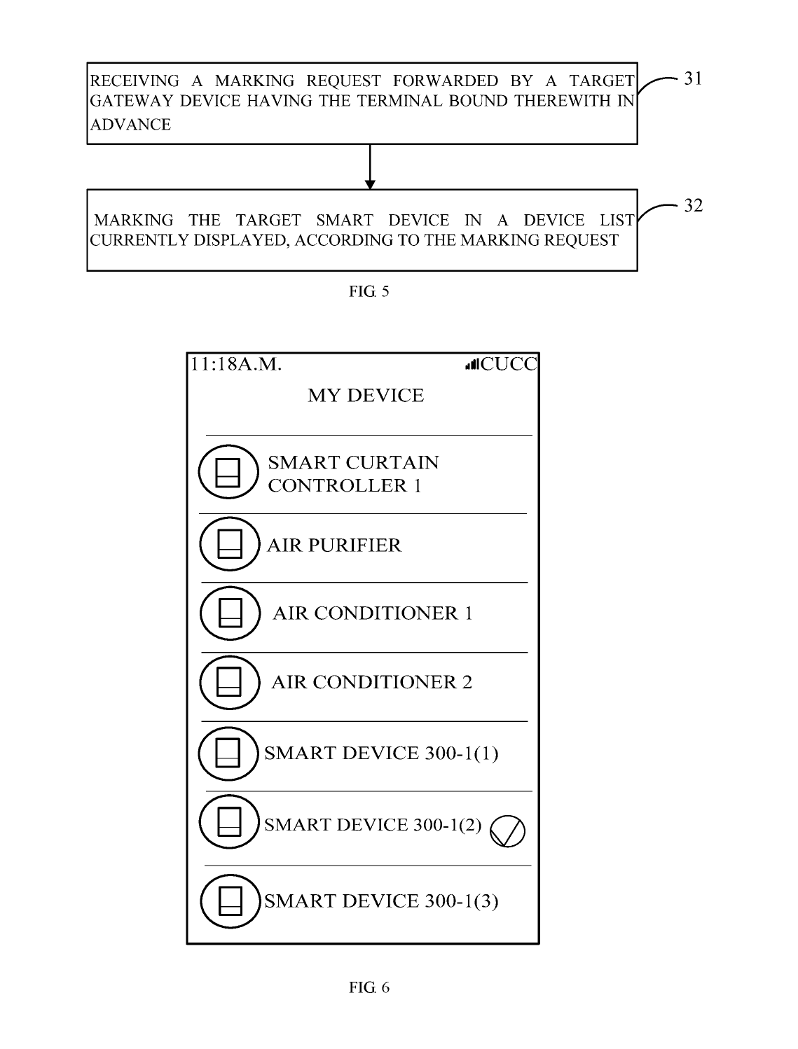

Alternatively or additionally, the user may set the preset label. For example, the preset identifier may be set as a designated symbol such as a triangle or a circle or may be set as a label in the form of a check identify, as shown in FIG. 6.

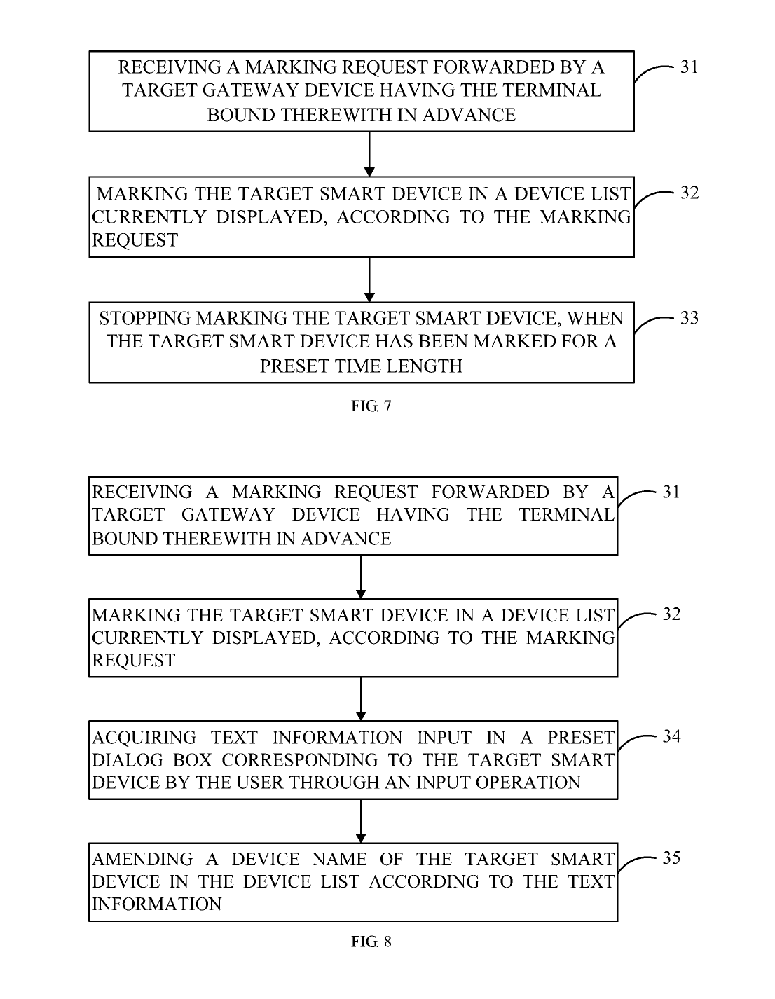

Alternatively or additionally, as shown in FIG. 7 which illustrates another device identifying method based on the embodiment shown in FIG. 5, the method further comprises the following steps after step 32 is executed.

In step 33, identifying of the target smart device is stopped, when the target smart device has been identified for a preset time length.

In this step, when the target smart device has been identified in the device list for the preset time length, identifying of the target smart device is stopped, thereby avoiding the problem that a user cannot correlate a physical target smart device with its visual representation in the device list caused by identifying a plurality of target smart devices in the device list after the user presses preset buttons on other target smart devices.

Alternatively or additionally, identifying of the target smart device may be stopped according to any of the following manners.

In a first manner, all smart devices in the device list are displayed in the same display manner.

The terminal may display all smart devices in the device list in the same display manner (for example, in a third display manner), instead of in different display manners.

Alternatively or additionally, the third display manner may be the same as the first display manner or the second display manner, or may be different from both the first display manner and the second display manner. If the third display manner is the same as the first display manner or the second display manner, when the user triggers a preset physical button on a further target smart device, the terminal displays the further target smart device in the first display manner and displays other smart devices in the second display manner. Because the first display manner is different from the second display manner, the further target smart device can still be identified in the device list.

For example, formerly, a target smart device was identified in the device list in a bold, red and “Song” font, while all other smart devices in the device list than the target smart device were identified in a black and “regular script” font. When the target smart device has been identified for the preset time length, all smart devices in the device list may be displayed in the bold, red and “Song” font or in the black and “regular script” font.

When a preset physical button on a further target smart device is triggered, the terminal identifies the further target smart device in the device list in the bold, red and “Song” font again and displays other smart devices in the black and “regular script” font.

Alternatively or additionally, to further improve user experience, another device identifying method is provided as shown in FIG. 8. The device identifying method shown in FIG. 8 is based on the embodiment shown in FIG. 5, and further comprises the following steps after step 32.

In step 34, text information input in a preset dialog box corresponding to the target smart device by the user through an input operation is acquired.

In this step, the user may input the text information in the preset dialog box through the input operation. The terminal may acquire the text information according to the input from a touch user interface or other user interfaces.

In step 35, a device name of the target smart device in the device list is amended according to the text information.

In this step, the terminal may amend the device name of the target smart device in the device list based on the text information.

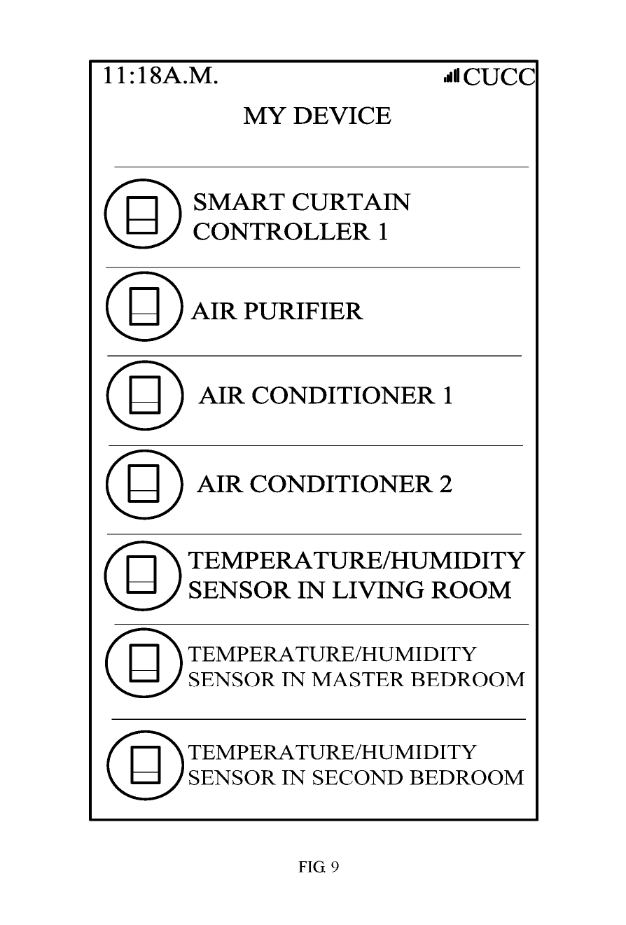

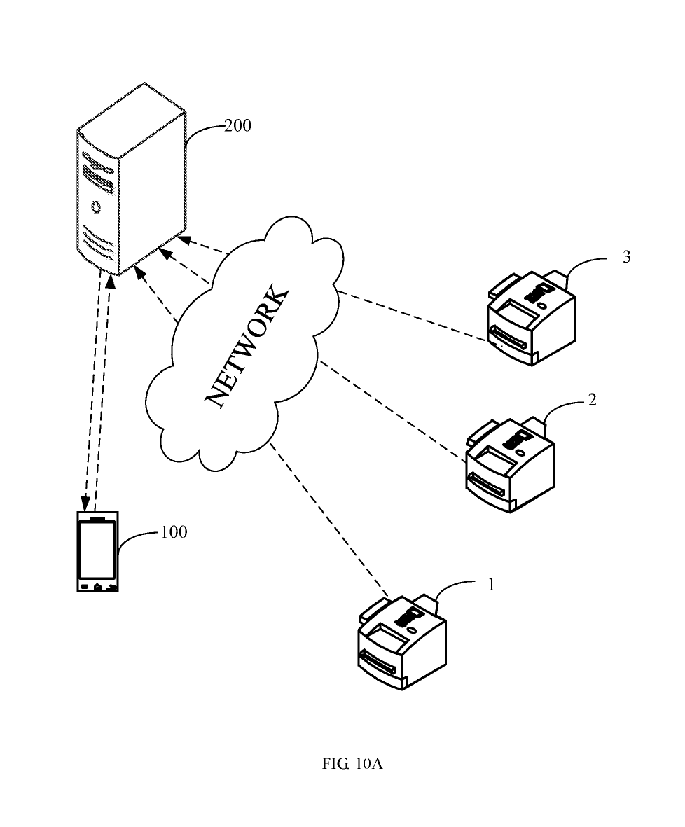

As shown in FIG. 9, based on the acquired text information, the terminal amends the device name of a target smart device in the device list from the original “smart device 300-1(1)” to “temperature/humidity sensor in living room”, amends the device name of another target smart device from the original “smart device 300-1(2)” to “temperature/humidity sensor in master bedroom”, and amends the device name of yet another target smart device from the original “smart device 300-1(3)” to “temperature/humidity sensor in second bedroom”.

The above process facilitates later remote control of the corresponding smart device in the device list by using the terminal (for example, controlling only the temperature/humidity sensor in the living room), thereby further improving user experience.

In the above embodiment, the terminal can automatically identify the target smart device in the device list currently displayed according to the received identifying request, thereby simplifying user operation. Moreover, the physical target smart device can be promptly correlated with its visual representation in the device list displayed on the terminal, thereby improving intelligence of the terminal and bringing convenience to the user.

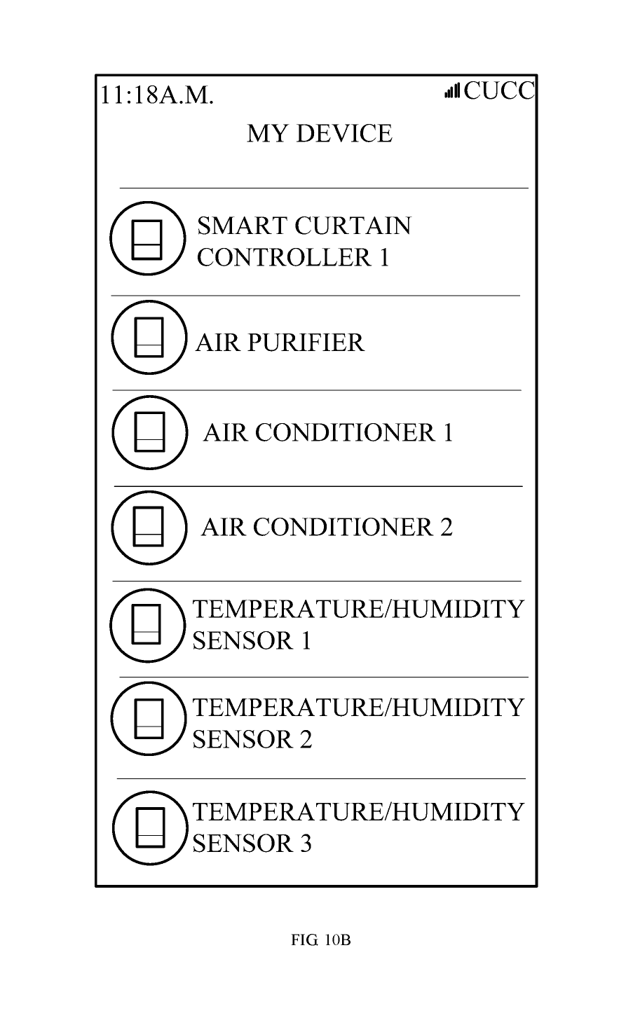

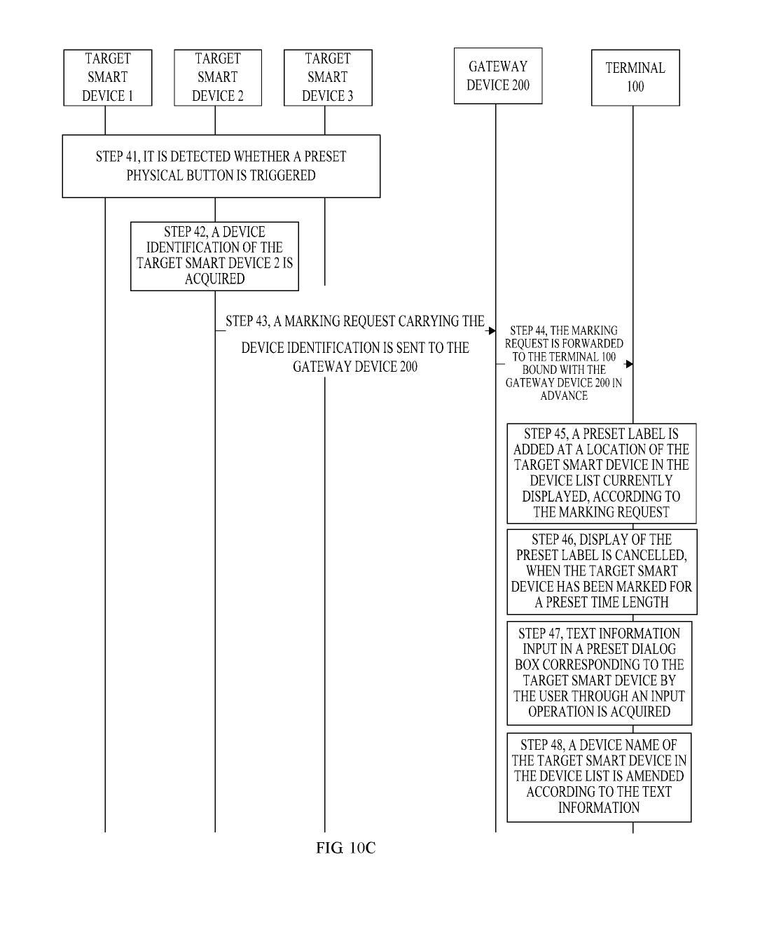

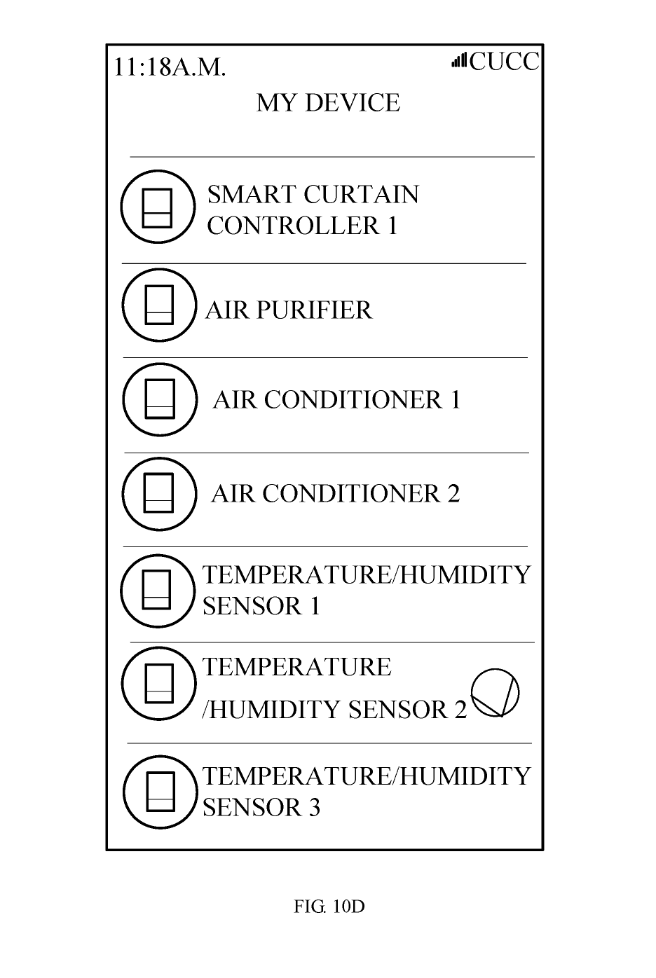

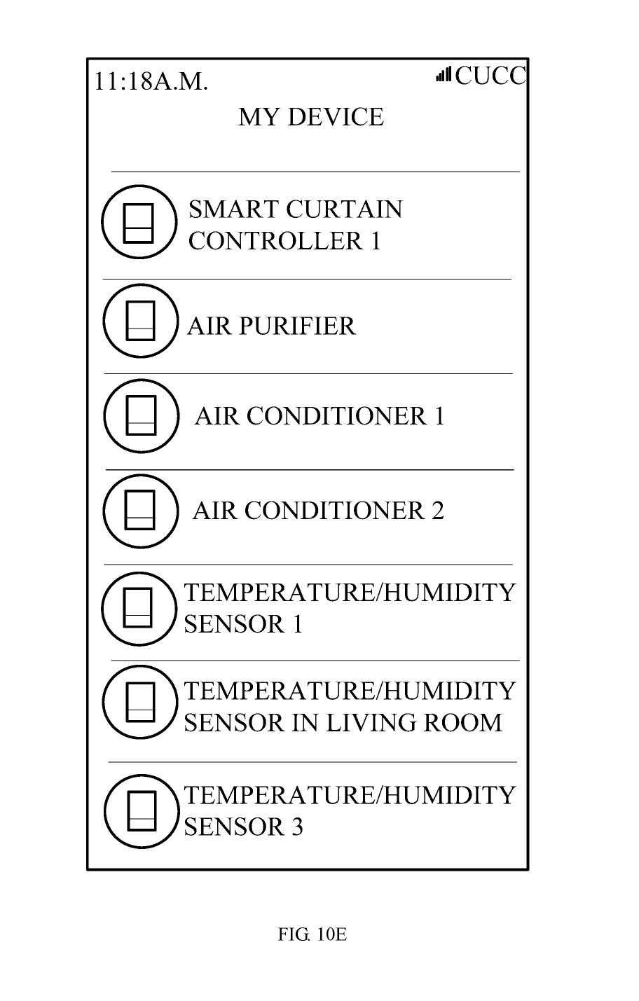

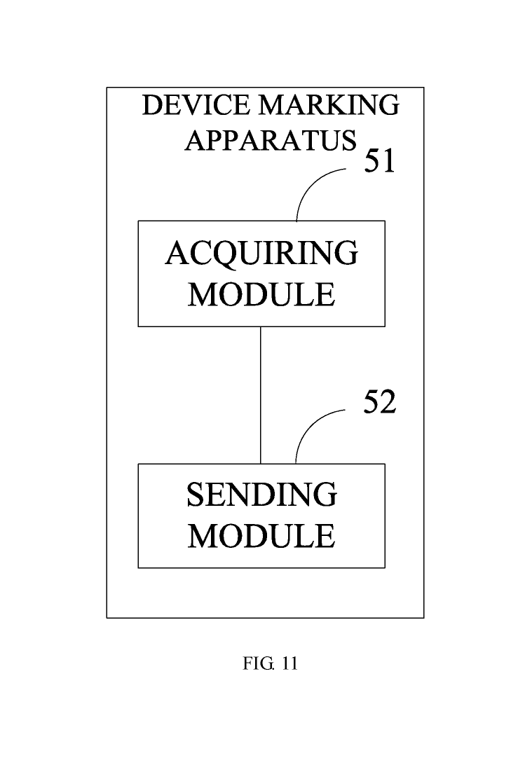

FIG. 10A is a schematic diagram of a scenario for device identifying according to an exemplary embodiment. A target smart device 1, a target smart device 2 and a target smart device 3 all access a gateway device 200 via wireless connections. The gateway device 200 has a terminal 100 bound therewith in advance. Supposing the target smart devices are all smart temperature/humidity sensors, then a device list currently displayed on the terminal includes all smart device information in the device list of the accessed gateway device 200, shown in FIG. 10B.

FIG. 10C illustrates a flowchart of another device identifying method according to an exemplary embodiment, which is provided in combination with FIGS. 10A and 10B. As shown, the method comprises the following steps.

In step 41, a target smart device detects whether a preset physical button is triggered.

In this step, it is supposed that the user selects the target smart device 2 in the living room as shown in FIG. 10A. That is, the preset physical button of the smart temperature/humidity sensor in the living room is triggered. The target smart devices each detects whether its preset physical button is triggered according to the prior art. In this case, the target smart device 2 in the living room detects that its preset physical button is triggered.

In step 42, when the preset physical button of the target smart device 2 is triggered, the target smart device 2 acquires a device identification of the target smart device 2.

In this step, the target smart device 2 acquires its own device identification.

In step 43, the target smart device 2 sends an identifying request carrying the device identification to the gateway device 200.

In step 44, the gateway device 200 forwards the identifying request to the terminal 100 bound with the gateway device 200 in advance.

In step 45, the terminal 100 adds a preset label at a location of the target smart device in the device list currently displayed, according to the identifying request.

In this step, the terminal may find the target smart device 2 in the device list according to the device identification carried by the identifying request, and add the preset label at the location of the target smart device 2, as shown in FIG. 10D.

In step 46, the terminal 100 cancels display of the preset label, when the target smart device has been identified for a preset time length.

In this step, when the target smart device has been identified for the preset time length, the terminal 100 may cancel display of the preset label by removing the preset label in the device list. Then, the device list is as shown in FIG. 10B.

In step 47, the terminal 100 acquires text information input in a preset dialog box corresponding to the target smart device by the user through an input operation.

In step 48, the terminal 100 amends a device name of the target smart device in the device list according to the text information.

In this step, the terminal 100 may amend the device name of the target smart device into “temperature/humidity sensor in living room” according to the text information, as shown in FIG. 10E.

In the one or more embodiments, when a plurality of smart devices are added to a target device during the same time period, a user may trigger a preset physical button on a target smart device. Then, the terminal automatically identifies the target smart device in a device list currently displayed, so that the user can correlate the physical target smart device with its visual representation in the device list displayed by the terminal. Therefore, it is easier for the user to remotely control the corresponding smart device in the device list by using the terminal later, improving intelligence of the terminal and bringing convenience to the user.

Correspondingly to the aforesaid method embodiments, the present disclosure also provides apparatus embodiments.

FIG. 11 is a block diagram of a device identifying apparatus according to an exemplary embodiment of the present disclosure. As shown, the apparatus comprises an acquiring module 51 and a sending module 52.

The acquiring module 51 is configured to acquire a device identification of the target smart device, when a preset physical button is triggered.

The sending module 52 is configured to send an identifying request carrying the device identification to a gateway device to which the target smart device connects, so that the gateway device forwards the identifying request to a terminal bound with the gateway device in advance.

The identifying request requests the terminal to identify the target smart device in a device list currently displayed, and the device list contains information on at least one smart device added into a device list of a target device.

In the disclosure, the target device may be the gateway device or the terminal.

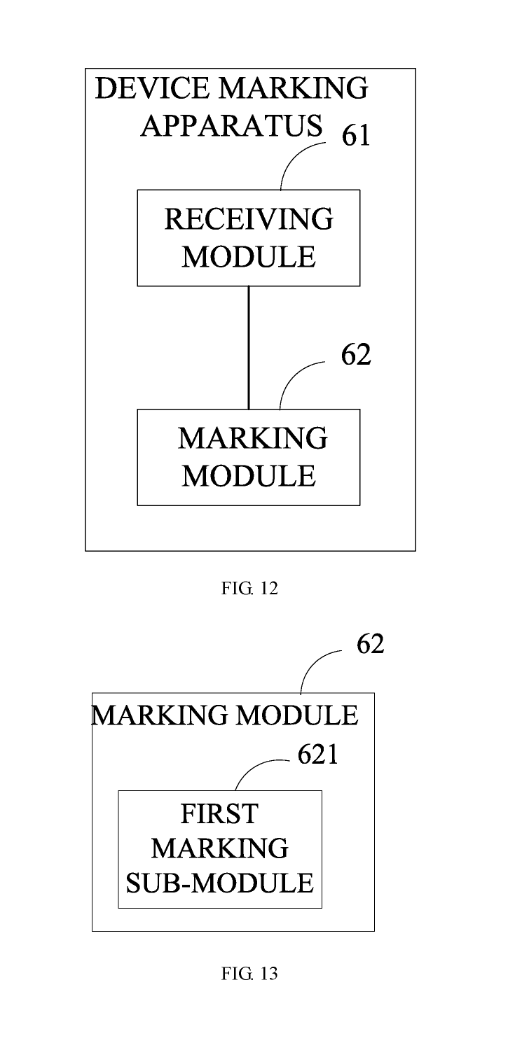

FIG. 12 is a block diagram of another device identifying apparatus according to an exemplary embodiment of the present disclosure. As shown, the apparatus comprises a receiving module 61 and an identifying module 62.

The receiving module 61 is configured to receive an identifying request forwarded by a gateway device having a terminal bound therewith in advance.

The identifying module 62 is configured to identify a target smart device in a device list currently displayed, according to the identifying request.

The identifying request requests the terminal to identify the target smart device in the device list and the identifying request carries a device identification of the target smart device, and the device list contains information on at least one smart device added into a device list of a target device.

FIG. 13 is a block diagram of yet another device identifying apparatus according to an exemplary embodiment of the present disclosure, which is based on the above-described embodiment shown in FIG. 12. As shown, the identifying module 62 comprises a first identifying sub-module 621.

The first identifying sub-module 621 is configured to, in the device list currently displayed, display the target smart device in a first display manner and display another smart device added to the target device other than the target smart device in a second display manner, the first display manner being different from the second display manner.

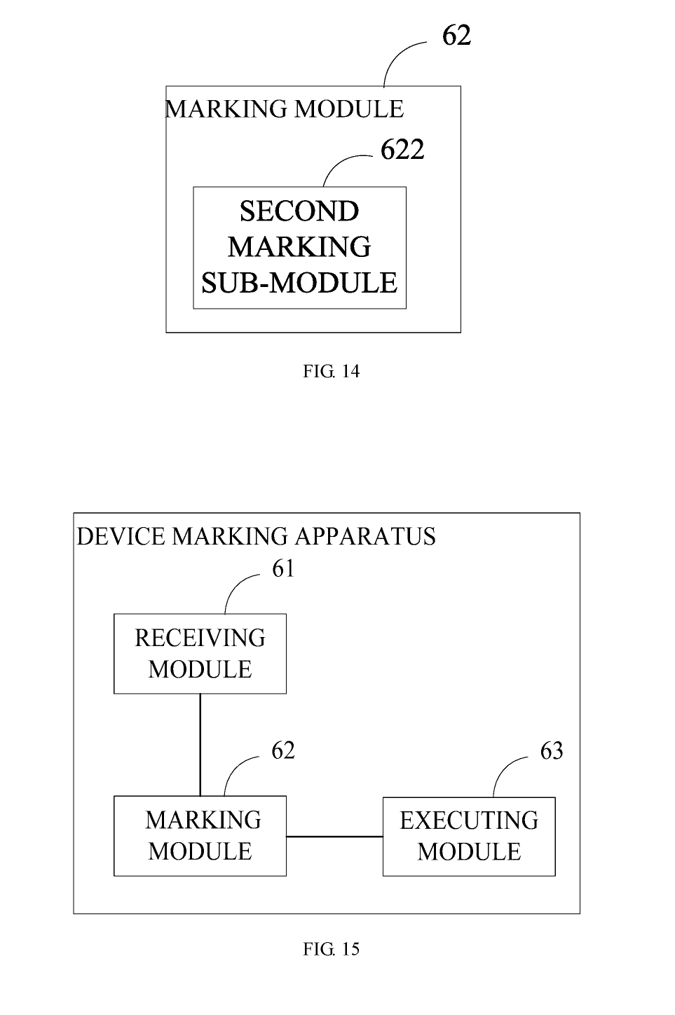

FIG. 14 is a block diagram of still another device identifying apparatus according to an exemplary embodiment of the present disclosure, which is based on the above-described embodiment shown in FIG. 12. As shown, the identifying module 62 comprises a second identifying sub-module 622.

The second identifying sub-module 622 is configured to add a preset label at a location of the target smart device in the device list currently displayed.

FIG. 15 is a block diagram of a further device identifying apparatus according to an exemplary embodiment of the present disclosure, which is based on the above-described embodiment shown in FIG. 12. As shown, the apparatus further comprises an executing module 63.

The executing module 63 is configured to stop identifying the target smart device, when the target smart device has been identified for a preset time length.

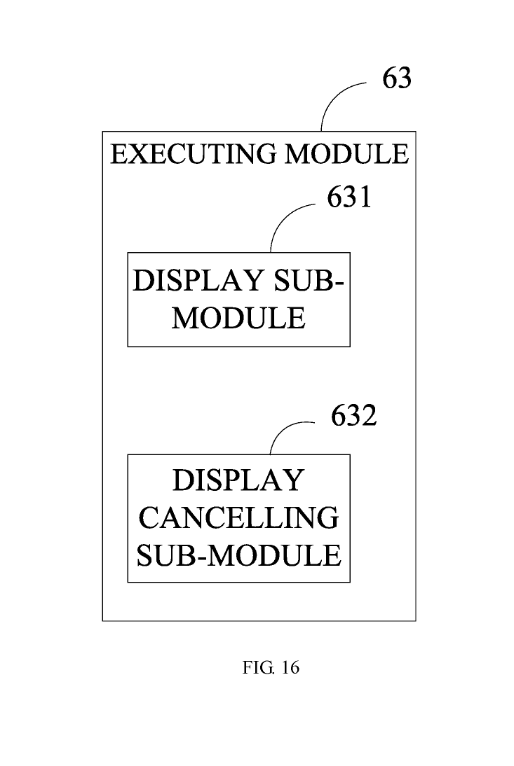

FIG. 16 is a block diagram of yet a further device identifying apparatus according to an exemplary embodiment of the present disclosure, which is based on the above-described embodiment shown in FIG. 15. As shown, the executing module 63 comprises a displaying sub-module 631 or a display cancelling sub-module 632.

The displaying sub-module 631 is configured to display all smart devices in the device list in a third display manner.

The display cancelling sub-module 632 is configured to cancel display of the preset label.

As to apparatus embodiments, reference can be made to the method embodiments, since the apparatus embodiments substantially correspond to the method embodiments. The apparatus embodiments mentioned above are merely illustrative. The units described as separated components may or may not be physically separated, and components displayed as units may or may not be physical units, i.e., they may be located at the same place or distributed over a plurality of network units. The object of the solution of the present disclosure may be achieved by selecting some or all of the modules as practically required, as can be appreciated and implemented by those skilled in the art without making inventive efforts.

Correspondingly, the present disclosure further provides a device identifying apparatus for use in a target smart device. The apparatus may include: a processor and a memory storing instructions executable by the processor. The processor is configured to: acquire a device identification of the target smart device, when a preset physical button is triggered; and send an identifying request carrying the device identification to a gateway device to which the target smart device connects, so that the gateway device forwards the identifying request to a terminal bound with the gateway device in advance. The identifying request requests the terminal to identify the target smart device in a device list currently displayed. The device list contains information on at least one smart device added into a device list of a target device.

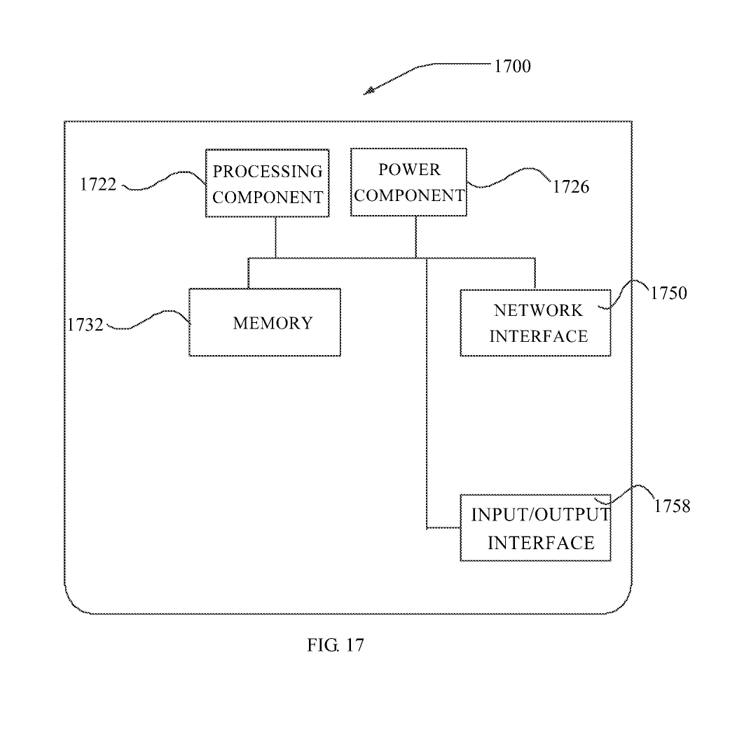

FIG. 17 is a schematic structural diagram of a device identifying apparatus 1700 according to an exemplary embodiment of the present disclosure. For example, the apparatus 1700 may be provided as a server or a smart device. Referring to FIG. 17, the apparatus 1700 may comprise: a processing component 1722 which further comprises one or more processors, and memory resources represented by a memory 1732 for storing instructions executable by the processing component 1722, such as applications. The applications stored in the memory 1732 may comprise one or more modules, each corresponding to a set of instructions. In addition, the processing component 1722 is configured to execute instructions to perform the above-described device identifying methods.

The apparatus 1700 may also include a power component 1726 configured to perform power management for the apparatus 1700, a wired or wireless network interfaces 1750 configured to connect the apparatus 1700 to a network, and an input/output interface 1758. The apparatus 1700 may operate an operating system stored in the memory 1732, such as Windows Server™Mac OS X™, Uni™, Linux™, FreeBSD™or the like.

Correspondingly, the present disclosure further provides a device identifying apparatus for use in a terminal. The apparatus comprises: a processor; and a memory storing instructions executable by the processor. The processor is configured to: receive an identifying request forwarded by a gateway device having the terminal bound therewith in advance; and identify a target smart device in a device list currently displayed, according to the identifying request, wherein the identifying request requests the terminal to identify the target smart device in the device list and the identifying request carries a device identification of the target smart device, and the device list contains information on at least one smart device added into a device list of a target device.

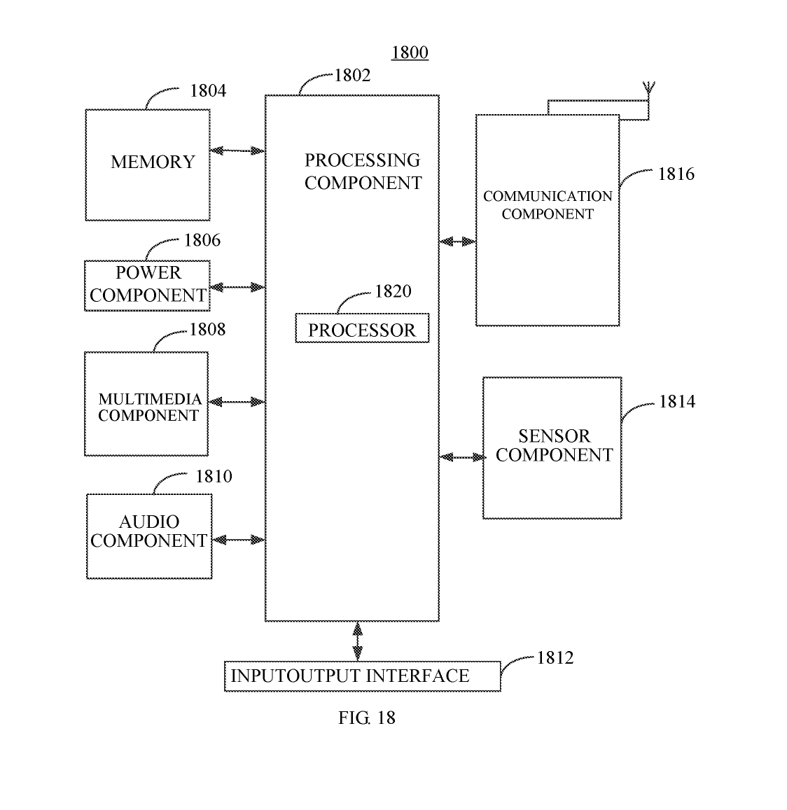

FIG. 18 is a schematic structural diagram of a device identifying apparatus 1800 according to an exemplary embodiment of the present disclosure. For example, the apparatus 1800 may be a mobile phone, a computer, a digital broadcast terminal, a messaging device, a smart socket, a smart blood pressure meter, a gaming console, a tablet, a medical device, exercise equipment, a personal digital assistant or the like.

As shown in FIG. 18, the apparatus 1800 may include one or more of the following components: a processing component 1802, a memory 1804, a power component 1806, a multimedia component 1808, an audio component 1810, an input/output (I/O) interface 1812, a sensor component 1814, and a communication component 1816.

The processing component 1802 typically controls overall operations of the apparatus 1800, such as the operations associated with display, telephone calls, data communications, camera operations, and recording operations. The processing component 1802 may include one or more processors 1820 to execute instructions to perform all or part of the steps in the above described methods. Moreover, the processing component 1802 may include one or more modules which facilitate the interaction between the processing component 1802 and other components. For instance, the processing component 1802 may include a multimedia module to facilitate the interaction between the multimedia component 1808 and the processing component 1802.

The memory 1804 is configured to store various types of data to support the operation of the apparatus 1800. Examples of such data include instructions for any applications or methods operated on the apparatus 1800, contact data, phonebook data, messages, pictures, video, etc. The memory 1804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1806 provides power to various components of the apparatus 1800. The power component 1806 may include a power management system, one or more power sources, and any other components associated with the generation, management, and distribution of power in the apparatus 1800.

The multimedia component 1808 includes a screen providing an output interface between the apparatus 1800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1808 includes a front camera and/or a rear camera. The front camera and the rear camera may receive an external multimedia datum while the apparatus 1800 is in an operation mode, such as a photographing mode or a video mode. Each of the front camera and the rear camera may be a fixed optical lens system or have focus and optical zoom capability.

The audio component 1810 is configured to output and/or input audio signals. For example, the audio component 1810 includes a microphone (“MIC”) configured to receive an external audio signal when the apparatus 1800 is in an operation mode, such as a call mode, a recording mode, and a voice recognition mode. The received audio signal may be further stored in the memory 1804 or transmitted via the communication component 1816. In some embodiments, the audio component 1810 further includes a speaker to output audio signals.

The I/O interface 1812 provides an interface between the processing component 1802 and peripheral interface modules, such as a keyboard, a click wheel, buttons, and the like. The buttons may include, but are not limited to, a home button, a volume button, a starting button, and a locking button.

The sensor component 1814 includes one or more sensors to provide status assessments of various aspects of the apparatus 1800. For instance, the sensor component 1814 may detect an open/closed status of the apparatus 1800, relative positioning of components, e.g., the display and the keypad, of the apparatus 1800, a change in position of the apparatus 1800 or a component of the apparatus 1800, a presence or absence of user contact with the apparatus 1800, an orientation or an acceleration/deceleration of the apparatus 1800, and a change in temperature of the apparatus 1800. The sensor component 1814 may include a proximity sensor configured to detect the presence of nearby objects without any physical contact. The sensor component 1814 may also include a light sensor, such as a CMOS or CCD image sensor, for use in imaging applications. In some embodiments, the sensor component 1814 may also include an accelerometer sensor, a gyroscope sensor, a magnetic sensor, a pressure sensor, or a temperature sensor.

The communication component 1816 is configured to facilitate communication, wired or wirelessly, between the apparatus 1800 and other devices. The apparatus 1800 can access a wireless network based on a communication standard, such as WiFi, 2G or 3G or a combination thereof. In one embodiment, the communication component 1816 receives a broadcast signal or broadcast associated information from an external broadcast management system via a broadcast channel. In one embodiment, the communication component 1816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In some embodiments, the apparatus 1800 may be implemented with one or more circuitries, which include application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components. The apparatus 1800 may use the circuitries in combination with the other hardware or software components for performing the above described methods. Each module, sub-module, unit, or sub-unit in the disclosure may be implemented at least partially using the one or more circuitries.

In one or more embodiments, there is also provided a non-transitory computer readable storage medium including instructions, such as included in the memory 1804, executable by the processor 1820 in the apparatus 1800, for performing the above-described methods. For example, the non-transitory computer readable storage medium may be a ROM, a RAM, a CD-ROM, a magnetic tape, a floppy disc, an optical data storage device, and the like.

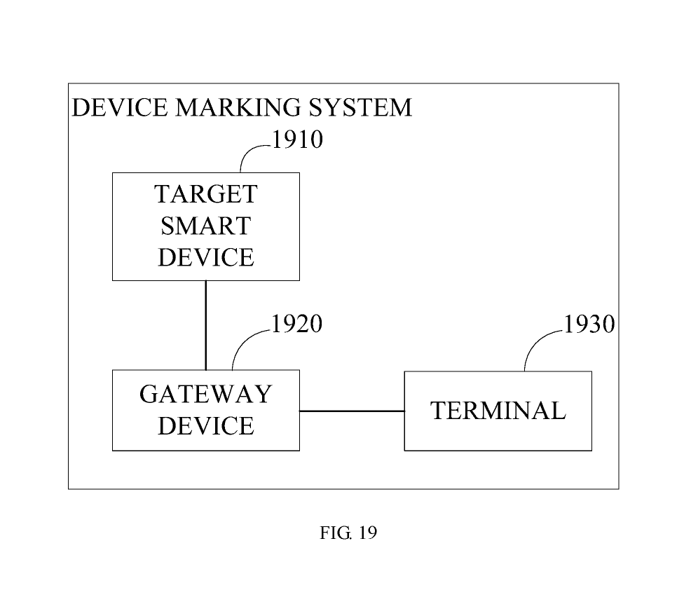

FIG. 19 is a block diagram of a device identifying system according to an exemplary embodiment of the present disclosure. The system may comprise: a target smart device 1910, which is the device identifying apparatus shown in FIG. 11; a gateway device 1920; and a terminal 1930, which is the device identifying apparatus shown in any of FIGS. 12 to 16.

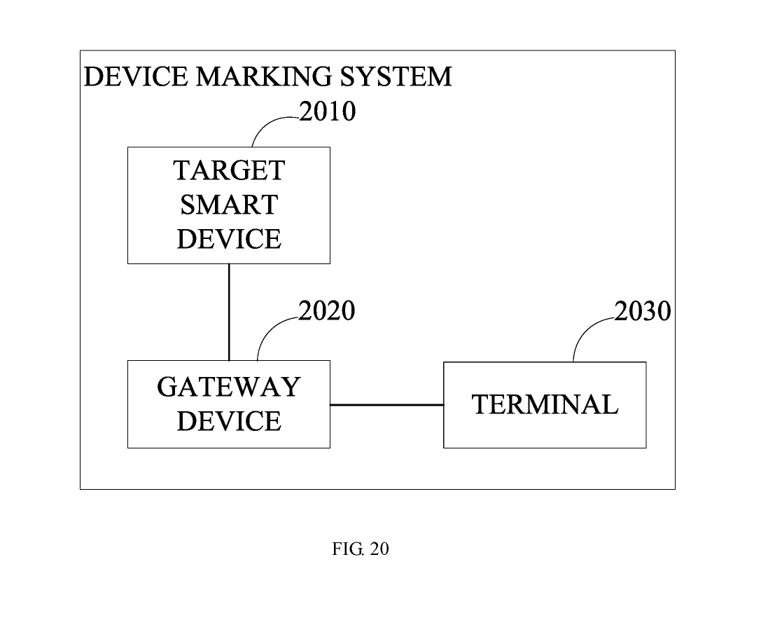

FIG. 20 is a block diagram of another device identifying system according to an exemplary embodiment of the present disclosure. The system may comprise: a target smart device 2010, which is the device identifying apparatus shown in FIG. 17; a gateway device 2020; and a terminal 2030, which is the device identifying apparatus shown in FIG. 18.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method, comprising:
receiving, by a terminal, an identifying request forwarded by a gateway device that is bound with the terminal; and
identifying, by the terminal, a target smart device in a device list currently displayed on the terminal, according to the identifying request,
wherein the device list contains information on a plurality of smart devices controlled by the terminal; and
wherein the identifying request requests the terminal to identify the target smart device in the device list and the identifying request carries a device identification of the target smart device.

2. The method of claim 1, wherein identifying the target smart device in the device list currently displayed comprises:
in the device list currently displayed, displaying the target smart device in a first display manner and displaying smart device other than the target smart device in a second display manner, the first display manner being different from the second display manner.

3. The method of claim 1, wherein identifying the target smart device in the device list currently displayed comprises:
adding a preset label to identify the target smart device in the device list currently displayed.

4. The method of claim 1, further comprising: after identifying the target smart device in the device list currently displayed,
stopping identifying the target smart device, when the target smart device has been identified for a preset time length.

5. The method of claim 4, wherein stopping identifying the target smart device comprises at least one of the following:
displaying all smart devices in the device list in a third display manner; and
removing the preset label.

6. An apparatus, the apparatus comprising:
a processor; and
a memory storing instructions executable by the processor,
wherein the processor is configured to:
receive an identifying request forwarded by a gateway device that is bound with the apparatus; and
identify a target smart device in a device list currently displayed, according to the identifying request,
wherein the identifying request requests the terminal to identify the target smart device in the device list and the identifying request carries a device identification of the target smart device, and the device list contains information on a plurality of smart devices controlled by the apparatus.

7. The apparatus according to claim 6, wherein the processor is further configured to:
in the device list currently displayed, display the target smart device in a first display manner and display smart devices other than the target smart device in a second display manner, the first display manner being different from the second display manner.

8. The apparatus according to claim 6, wherein the processor is further configured to:
add a preset label at a location of the target smart device in the device list currently displayed.

9. The apparatus according to claim 6, wherein the processor is further configured to:
after identifying the target smart device in the device list currently displayed, stop identifying the target smart device, when the target smart device has been identified for a preset time length.

10. The device identifying apparatus for use in a terminal according to claim 9, wherein stopping identifying the target smart device comprises at least one of:
displaying all smart devices in the device list in a third display manner; and
removing the preset label.

11. A non-transitory computer-readable storage medium having stored therein instructions that, when executed by a processor of a mobile terminal, cause the mobile terminal to perform acts comprising:
receiving an identifying request forwarded by a gateway device having the mobile terminal bound therewith in advance; and
identifying a target smart device in a device list currently displayed, according to the identifying request,
wherein the identifying request requests the mobile terminal to identify the target smart device in the device list and the identifying request carries a device identification of the target smart device, and the device list contains information on a plurality of smart devices controlled by the mobile terminal.

12. The storage medium according to claim 11, wherein identifying the target smart device in the device list currently displayed comprises:
in the device list currently displayed, displaying the target smart device in a first display manner and displaying smart device other than the target smart device in a second display manner, the first display manner being different from the second display manner.

13. The storage medium according to claim 11, wherein identifying the target smart device in the device list currently displayed comprises:
adding a preset label at a location of the target smart device in the device list currently displayed.

14. The storage medium according to claim 11, wherein the method further comprises:
after identifying the target smart device in the device list currently displayed, stopping identifying the target smart device, when the target smart device has been identified for a preset time length.

15. The storage medium according to claim 14, wherein stopping identifying the target smart device comprises at least one of:
displaying all smart devices in the device list in a third display manner; and
removing the preset label.
